(19) United States
(12) Patent Application Publication
(10) Pub. No.: US 2026/0066676 A1
(43) Pub. Date: Mar. 5, 2026

(54) PORTABLE ENERGY STORAGE DEVICE CAPABLE OF SIMULTANEOUS MULTI-PORT CHARGING AND DISCHARGING AND METHOD FOR ALLOCATING CHARGING AND DISCHARGING POWER

(71) Applicant: NINGBO SOYAR TECHNOLOGY INNOVATION CO., LTD., Ningbo (CN)

(72) Inventor: Tao HUANG, Ningbo (CN)

(73) Assignee: NINGBO SOYAR TECHNOLOGY INNOVATION CO., LTD., Ningbo (CN)

(21) Appl. No.: 19/276,572

(22) Filed: Jul. 22, 2025

(30) Foreign Application Priority Data
Sep. 4, 2024 (CN) 2024112367655

(51) Int. Cl. H02J 7/00; H02J 7/34

(52) U.S. Cl. CPC H02J 7/50; H02J 7/342; H02J 7/62; H02J 7/64; H02J 7/65; H02J 7/663; H02J 7/933

(57) ABSTRACT

A portable energy storage device capable of simultaneous multi-port charging and discharging and method for allocating charging and discharging power, wherein the energy storage device includes a power allocation unit, at least two power input ports, and at least two charging output ports, wherein the power allocation unit is used for allocating power to the power input ports connected to the charging device and the charging output ports connected to the receiving device, and the maximum permissible operating power of the energy storage device in charging and discharging mode is defined as Pₘₐₓ. By distributing the power of the power input port and the charging output port, the portable energy storage device is enabled to meet the demand for simultaneous charging and simultaneous power supply, ensuring a good user experience.

### FIELD OF THE INVENTION

This invention relates to the technical field of mobile power supplies, specifically to a portable energy storage device capable of simultaneous multi-port charging and discharging, as well as a power allocation method for charging and discharging applied to such a device.

### BACKGROUND

With the widespread use of mobile devices and the increase in outdoor activities, the demand for portable energy storage devices has grown significantly. Whether for outdoor camping, emergency power needs, or everyday charging of mobile devices, portable energy storage devices that provide reliable power have become an indispensable tool.

Traditional portable energy storage devices usually only support single-interface charging or discharging functions, making them incapable of meeting the needs for simultaneously charging multiple devices or providing power to multiple devices. Although portable energy storage devices capable of connecting to multiple devices have been developed in existing technologies, how to reasonably allocate the appropriate power to each device and avoid overload or damage to the devices remains a challenge.

Moreover, in existing technologies, portable energy storage devices that are simultaneously charging and discharging lack appropriate rules for power allocation, which results in internal circuit boards operating under high load. This can lead to excessive heat generation, which in turn causes damage to the battery performance of the portable energy storage device. Furthermore, instability in voltage could potentially damage the connected device batteries.

### SUMMARY OF THE INVENTION

In response to the deficiencies in existing technology, the objective of this invention is to provide a portable energy storage device capable of simultaneous multi-port charging and discharging and method for allocating charging and discharging power. By cleverly designing power distribution rules, this invention enables the portable energy storage device to operate safely while performing simultaneous charging and discharging, as well as simultaneous multi-port charging and multi-port discharging.

To achieve the aforementioned objective, the present invention provides the following technical solution:
according to the first aspect of the present invention, a portable energy storage device capable of simultaneous multi-port charging and discharging is provided, comprising a power allocation unit, at least two power input ports, and at least two charging output ports; the power allocation unit is configured to distribute power to the power input ports connected to charging devices and the charging output ports connected to powered devices; the state in which the power input ports are connected to charging devices while the charging output ports are simultaneously connected to powered devices is defined as the simultaneous charging and discharging state;
define the maximum allowable operating power of the portable energy storage device under the state of charging and discharging as Pₘₐₓ, the power allocation unit configures ½ of Pₘₐₓ as the maximum allowable input power of the power input port, and configures the sum of actual charging power of the power input port to be the maximum total output power of the charging output port; Define the maximum allowable input power of the power input port to be P_{max_in} and the maximum total output power of the charging output port to be P_{max_out}; then P_{max_in}=Pₘₐₓ/2, P_{max_out}=the sum of the actual charging power of the power input port, and P_{max_out}≤P_{max_in};
when the sum of the maximum allowable charging power of the power input ports connected to charging devices is less than or equal to P_{max_in}, the power allocation unit configures each power input port to operate at its respective maximum allowable charging power; the maximum allowable charging power is defined as the smaller value between the preset maximum charging power of the power input port and the charging power that the charging device can provide upon connection; when the sum of the maximum allowable charging power of the power input ports connected to charging devices exceeds P_{max_in}, the power allocation unit sets the total operating power of these power input ports to P_{max_in};
when the sum of the preset power of the charging output ports connected to powered devices is less than or equal to P_{max_out}, the power allocation unit assigns each charging output port its corresponding preset power; the preset power is defined as the smaller value between the maximum output power of the charging output port and the power requested by the connected load; when the sum of the preset power of the charging output ports connected to powered devices exceeds P_{max_out}, the power allocation unit ensures that the total power distributed to these charging output ports equals P_{max_out}.

Furthermore, when the sum of the maximum allowable charging power of the power input ports connected to charging devices exceeds P_{max_in}, the power allocation unit sets the total operating power of these power input ports to P_{max_in} and allocates power according to the following rules:
if the number of power input ports connected to charging devices is one, the power allocation unit configures that power input port to operate at P_{max_in};
if the number of power input ports connected to charging devices is N, where N is a positive integer and N≥2, then:
if the maximum allowable charging power of each power input port is greater than P_{max_in}/N, the power allocation unit configures all these power input ports to operate at P_{max_in}/N;
if some power input ports have a maximum allowable charging power which is less than or equal to P_{max_in}/N, the power allocation unit performs a first power allocation, configuring these power input ports to operate at their maximum allowable charging power; assuming the total power consumed by these power input ports is B₁, the remaining power available for allocation is P₁=P_{max_in}−B₁: the number of power input ports that have not yet been allocated power is M₁ which equals to N−(the number of power input ports configured to operate at their maximum allowable charging power in the first allocation); for the remaining M₁ power input ports:
if the maximum allowable charging power of each remaining power input port is greater than P₁/M₁, the power allocation unit configures all M₁ remaining power input ports to operate at P₁/M₁;
if the maximum allowable charging power of some power input ports is less than or equal to P₁/M₁, then the power allocation unit allocates power in accordance with the following rule: after the k-th power allocation, the total power consumed by the power input ports configured to operate at their maximum allowable charging power is defined as Bₖ; the remaining power available for allocation is defined as Pₖ, and the number of power input ports that have not yet been allocated power is defined as Mₖ, where k is a positive integer and k≥1;
among the remaining Mₖ ports, for the power input ports with a maximum allowable charging power which is less than or equal to Pₖ/Mₖ, the power allocation unit performs the (k+1)-th power allocation, configuring these power input ports to operate at their maximum allowable charging power; assuming the total power consumed by these power input ports is Bₖ₊₁, the remaining power available for allocation is Pₖ₊₁=P_{max_in} B₁ . . . Bₖ₊₁, and the number of power input ports that have not yet been allocated power is Mₖ₊₁=Mₖ−(the number of power input ports configured to operate at their maximum allowable charging power in the (k+1)-th allocation; in this rule, after the (k+1)-th power allocation, if the maximum allowable charging power of all the remaining Mₖ₊₁ power input ports is greater than Pₖ₊₁/Mₖ₊₁, the rule terminates and the power allocation unit configures the remaining Mₖ₊₁ power input ports to operate at Pₖ₊₁/Mₖ₊₁.

Furthermore, when the sum of the preset power of the charging output ports connected to powered devices exceeds P_{max_out}, the power allocation unit distributes a total power of P_{max_out} among these charging output ports and allocates power according to the following rules:
the charging output ports are preconfigured with a priority order for power allocation, and each charging output port is preassigned a minimum output power and a maximum output power;
the sum of the minimum output power of all charging output ports is less than or equal to P_{max_out}, and the minimum output power of each charging output port is less than or equal to its maximum output power; additionally, the maximum output power of each charging output port is less than or equal to P_{max_out};
if the sum of the minimum output power of the charging output ports connected to powered devices is equal to P_{max_out}, the power allocation unit assigns each charging output port its corresponding minimum output power;
if the sum of the minimum output power of the charging output ports connected to powered devices is less than P_{max_out}, and P_{max_out} is less than the sum of the preset power of these charging output ports, the power allocation unit first satisfies the minimum output power requirements of these charging output ports; then, it distributes the remaining power according to the priority order of the charging output ports, where the remaining power is given by:

remaining Power=P_{max_out}−Sum of Minimum Output Power of Charging Output Ports.

Furthermore, when the sum of the minimum output power of the charging output ports connected to powered devices is less than P_{max_out}, and P_{max_out} is less than the sum of the preset power of these charging output ports, the power allocation unit, after satisfying the minimum output power requirements of these charging output ports, distributes the remaining power according to the priority order of the charging output ports based on the following rules:
define the number of charging output ports connected to powered devices as Y; when Y≥2 and these Y charging output ports have different priority levels, they are sorted in descending order of priority and sequentially designated as the first charging output port through the Y-th charging output port; their respective minimum output power values are sequentially defined as P_{min_c1} to P_{min_cY}, and the smaller value between their maximum output power and load request power is sequentially defined as the first preset power through the Y-th preset power;
define the initial amount of remaining power as P_{0_out}, where: P_{0_out}=P_{max_out} (P_{min_c1}+ . . . +P_{min_cY}); during the first round of remaining power allocation, the power allocation unit assigns the first charging output port a total power equal to the smaller value between (P_{min_c1}+P_{0_out}) and the first preset power; Define the remaining power obtained by the first charging output port after the first round of allocation as C₁, where: C₁=total power allocated to the first charging output port−P_{min_c1}: define the remaining power after the first round of allocation as P_{1_out}, where: P_{1_out}=P_{0_out}−C₁; if P_{1_out}=0, the power allocation process ends; if P_{1_out}>0, the remaining power allocation continues according to the following rule until the remaining power P_{k_out}=0, thereby completing the power allocation process: in the k-th round of remaining power allocation, the power allocation unit assigns the k-th charging output port a total power equal to the smaller value between (P_{min_ck}+P₍ₖ₋₁₎ₒᵤₜ) and the k-th preset power; define the remaining power obtained by the k-th charging output port after the k-th round of allocation as Cₖ, where: Cₖ=Total power allocated to the k-th charging output port−P_{min_ck}; define the remaining power after the k-th round of allocation as P_{k_out}, where: P_{k_out}=P_{0_out}−C₁− . . . −Cₖ, where k is a positive integer and k≥2.

Furthermore, when the sum of the minimum output power of the connected charging output ports is less than P_{max_out}, and P_{max_out} is less than the sum of the preset power of these charging output ports, the power allocation unit, after ensuring that each charging output port receives its minimum output power, distributes the remaining power according to the priority order of the charging output ports based on the following rules:
define the number of charging output ports connected to the powered devices as Y; among these Y charging output ports, the number of charging output ports with the same lowest priority is x, while the remaining Y−x charging output ports have different priority levels; Then:
when Y≥2 and Y=x, meaning that all Y charging output ports share the same lowest priority, the power allocation unit first ensures that these charging output ports receive their respective minimum output power and then evenly distributes the remaining power among them;
when Y≥3 and 2≤x<Y, the charging output ports are sorted in order of priority from high to low; these ports are sequentially defined from the first charging output port to the Y-th charging output port, where the priority of charging output ports from the (Y−x+1)-th to the Y-th is the same; the minimum output power of these charging output ports is sequentially defined as P_{min_c1} to P_{min_cY}, and the smaller value between their maximum output power and load request power is sequentially defined as the first preset power through the Y-th preset power; define the initial amount of remaining power as P_{0_out}, where: P_{0_out}=P_{max_out} (P_{min_c1}+ . . . +P_{min_cY}); The remaining power distribution rule is as follows:
in the first round of remaining power distribution, the power allocation unit assigns the total power to the first charging output port, which is the smaller value between (P_{min_c1}+remaining power P_{0_out}) and the first preset power; define the remaining power obtained by the first charging output port after the first round of remaining power distribution as C₁, where: C₁=Total power allocated to the first charging output port-P_{min_c1}; define the remaining remaining power after the first round of distribution as P_{1_out}, where: P_{1_out}=P_{0_out}−C₁; if P_{1_out}=0, the power allocation ends; if P_{1_out}>0 and only x charging output ports have not been allocated remaining power, the power allocation unit will evenly distribute the remaining power P_{1_out} among these x charging output ports, and the power allocation ends; if P_{1_out}>0 and more than x charging output ports still require power allocation, the power allocation unit continues the remaining power distribution according to the following rules until one of the following conditions is met:
the remaining power distribution rule is as follows: in the k-th round of remaining power distribution, the power allocation unit allocates the total power to the k-th charging output port, which is the smaller value between (P_{min_ck}+remaining powerP_{k-1_out}) and the k-th preset power; define the remaining power obtained by the k-th charging output port after the k-th round of remaining power distribution as Cₖ, where: Cₖ=Total power allocated to the k-th charging output port−P_{min_ck}; define the remaining power after the k-th round of distribution as P_{k_out}, where: P_{k_out}=P_{0_out}−C₁− . . . −Cₖ;
the first condition is: the remaining power P_{k_out} equals 0; the second condition is: the remaining power P_{k_out} is greater than 0, and only x charging output ports have not yet been allocated the remaining power; if the first condition is met first, the power distribution ends; if the second condition is met first, the remaining power P_{k_out} will be evenly distributed among the remaining x charging output ports, and then the power distribution ends, where k is a positive integer and k≥2.

Furthermore, the number of power input ports is two, and the number of charging output ports is four; the two power input ports are bidirectional ports capable of both charging and discharging, and two of the charging output ports are the said bidirectional ports.

Furthermore, the device is internally equipped with a main control board and one or more independent circuit boards connected to the main control board. the power input ports and charging output ports are arranged on the circuit boards, while the power allocation unit is configured on the main control board.

Furthermore, the power allocation unit configures the charging and discharging power of each power input port and charging output port by reading the preset parameters of the power input ports and charging output ports, calculating their real-time power demands accordingly; The preset parameters include current and voltage.

Furthermore, both the charging/discharging interface circuit board and the main control board are equipped with protection circuits; the protection circuits include one or more of an overcurrent protection circuit, an overvoltage protection circuit, an overtemperature protection circuit, and a short-circuit protection circuit; when an abnormal condition is detected, the protection circuit responds and cuts off the power supply to the relevant circuit.

According to the second aspect of the present invention, a method for allocating charging and discharging power in a portable energy storage device is provided, applied to a portable energy storage device capable of simultaneous multi-port charging and discharging, wherein the portable energy storage device comprises a power allocation unit, at least two power input ports, and at least two charging output ports; the power allocation unit is configured to allocate power to the power input ports connected to charging devices and the charging output ports connected to receiving devices; the state in which the power input ports are connected to charging devices while the charging output ports are also connected to receiving devices is defined as the charge-discharge simultaneous operation state;
the power allocation method for charging and discharging includes:
defining the maximum allowable operating power of the portable energy storage device in the charge-discharge simultaneous operation state as Pₘₐₓ; the power allocation unit configures ½ of Pₘₐₓ as the maximum allowable input power for the power input ports and ensures that the total actual charging power of the power input ports equals the maximum total output power of the charging output ports; defining the maximum allowable input power of the power input ports as P_{max_in} and the maximum total output power of the charging output ports as P_{max_out}, the relationships are: P_{max_in}=Pₘₐₓ/2, P_{max_out}=total actual charging power of the power input ports, with the condition P_{max_out}≤P_{max_in};
when the sum of the maximum allowable charging power of the connected power input ports is less than or equal to P_{max_in}, the power allocation unit configures these power input ports to operate at their respective maximum allowable charging power; the maximum allowable charging power is the smaller value between the preconfigured maximum charging power of the power input port and the charging power that the connected charging device can provide when plugged into that port; when the sum of the maximum allowable charging power of the connected power input ports>P_{max_in}, the power allocation unit configures these power input ports to operate with a total power equal to P_{max_in};
when the sum of the preset power of the connected charging output ports is less than or equal to P_{max_out}, the power allocation unit assigns each connected charging output port its corresponding preset power; the preset power is the smaller value between the maximum output power of the charging output port and the power requested by the load connected to that port; when the sum of the preset power of the connected charging output ports exceeds P_{max_out}, the power allocation unit ensures that the total power allocated to these charging output ports is P_{max_out}.

Compared with the prior art, the invention has the following beneficial effects: the portable energy storage device capable of simultaneous multi-port charging and discharging and method for allocating charging and discharging power provided by the present invention enable the portable energy storage device to meet the simultaneous charging and simultaneous power supply needs. This ensures a good user experience by effectively distributing the power across the power input ports and charging output ports.

### BRIEF DESCRIPTION OF THE DRAWINGS

FIG. 1 illustrates a schematic diagram of the portable energy storage device in the first embodiment, where there are two power input ports and two charging output ports.

FIG. 2 illustrates a partial schematic diagram of the portable energy storage device in the second embodiment, where there are two power input ports.

FIG. 3 illustrates a partial schematic diagram of the portable energy storage device in the second embodiment, where there are three power input ports.

FIG. 4 illustrates a partial schematic diagram of the portable energy storage device in the third embodiment, where there are two charging output ports.

FIG. 5 illustrates a partial schematic diagram of the portable energy storage device in the third embodiment, where there are three charging output ports.

FIG. 6 illustrates a partial schematic diagram of the portable energy storage device in the third embodiment, where there are four charging output ports.

### LEGEND

101: First power input port
102: Second power input port
103: Third power input port
201: Power allocation unit
301: First charging output port
302: Second charging output port
303: Third charging output port
304: Fourth charging output port

### EMBODIMENT

To clarify the purpose, technical solution, and advantages of the embodiments described herein, the following detailed description of the embodiments provided in the accompanying drawings is presented. It is understood that the described embodiments are part of this application, and not all possible embodiments are depicted. Components shown and described in the drawings can be arranged and designed in various configurations.

Therefore, the detailed description of the embodiments provided in the drawings is not intended to limit the scope of the claims of this application, but only to represent selected embodiments thereof. All other embodiments obtained by those skilled in the art without creative labor based on the embodiments disclosed herein are within the scope of protection of this application.

It should be noted that similar numerals and letters in the following drawings represent similar elements. Therefore, once an element is defined in one drawing, it does not need to be further defined or explained in subsequent drawings. Additionally, all directional indications (such as up, down, left, right, front, rear, bottom, etc.) used in this application are for explaining the relative positional relationships and movements of the components in a specific orientation (as shown in the drawings). If this specific orientation changes, the directional indications also change Accordingly. Furthermore, descriptions involving “first,” “second,” etc., are used for descriptive purposes only and should not be construed to indicate or imply relative importance or the quantity of the indicated technical features.

In addition, in the present invention, the terms “those,” “and,” “all,” etc., do not necessarily require the number of power input ports or charging output ports to be at least 2, and also include the case where there is only 1 power input port or charging output port. For example, “those power input ports” includes the case of “that one power input port,” and “the sum of the maximum allowed charging power of those power input ports” includes “the maximum allowed charging power of that one power input port.” Furthermore, in the present invention, when the two values A and B are equal, either one of them is considered the smaller value. For example, the phrase “using the smaller of A and B as the maximum allowed charging power” includes the case where A and B are equal.

### Embodiment 1

This embodiment provides a portable energy storage device capable of simultaneous multi-port charging and discharging. Structurally, the device features a lightweight and high-strength outer casing. Internally, it includes one or more independent circuit boards, each equipped with power input and charging output ports. These circuit boards are connected to the main control board via wiring. An intelligent control chip is embedded in the main control board, incorporating a power allocation unit 201 that executes power distribution algorithms. The power allocation unit 201 reads parameters such as current and voltage at each port to calculate real-time power demands and adjusts the charging and discharging power accordingly. Additionally, the circuit boards and the main control board are equipped with protective circuit components, including overcurrent protection, overvoltage protection, overtemperature protection, and short-circuit protection. These protection circuits respond rapidly and cut off power to the relevant circuits when anomalies are detected. Since the core of this embodiment lies in the power distribution logic under simultaneous charging and discharging conditions, a detailed explanation is provided below:

This embodiment provides a portable energy storage device capable of simultaneous multi-port charging and discharging. The device includes a power allocation unit 201, at least two power input ports, and at least two charging output ports (as illustrated in FIG. 1, which depicts a case where both the power input and charging output ports are two in number). The power input ports are designed to connect to external charging devices to charge the portable energy storage device itself, while the charging output ports are intended to connect to external powered devices, enabling the portable energy storage device to supply power to them. The charging devices can be various types of power sources, while the powered devices can include various electronic devices such as smartphones, cameras, etc. The power allocation unit 201 distributes power between the power input ports connected to charging devices and the charging output ports connected to powered devices. (It can be understood that no power is allocated to power input ports that are not connected to charging devices or charging output ports that are not connected to powered devices). When at least one power input port is connected to a charging device and at least one charging output port is connected to a powered device, this state is defined as the simultaneous charging and discharging mode. In this mode, the maximum allowable operating power of the portable energy storage device is defined as Pₘₐₓ.

The power allocation unit 201 sets half of the maximum allowable operating power Pₘₐₓ of the portable energy storage device as the maximum allowable total input power for the power input ports. It also configures the total actual charging power of the power input ports as the maximum total output power of the charging output ports. Defining the maximum allowable total input power of the power input ports as P_{max_in} and the maximum total output power of the charging output ports as P_{max_out}, the following conditions hold when at least one power input port is connected to a charging device and at least one charging output port is connected to a powered device: P_{max_in}=Pₘₐₓ/2, P_{max_out}=Σ(actual charging power of power input ports), and P_{max_out}≤P_{max_in}, thus, P_{max_out}≤Pₘₐₓ/2.

Furthermore, for the power input ports:
1. When the sum of the maximum allowable charging power of all connected charging devices does not exceed P_{max_in}, the power allocation unit 201 configures each power input port to operate at its respective maximum allowable charging power. (The maximum allowable charging power for a power input port is defined as the smaller value between its preset maximum charging power and the charging power that the connected charging device can provide). For example:
(1) When only one power input port is connected to a charging device, suppose the charging device can provide a charging power of 60 W, while the preset maximum charging power of the power input port is 70 W. Since the charging power provided by the device (60 W) is less than the preset maximum charging power of the port (70 W), the maximum allowable charging power for this power input port is 60 W. Now, assuming the maximum allowable total input power of the portable energy storage device P_{max_in} is 100 W, and since the maximum allowable charging power of this port (60 W) is less than P_{max_in}, the power allocation unit 201 configures this power input port to operate at its maximum allowable charging power, which is 60 W.
(2) When two power input ports are connected to charging devices, for clarity and case of description, these two power input ports are defined as the first power input port 101 and the second power input port 102. Additionally, the maximum allowable charging power for the first power input port 101 and the second power input port 102 are defined as P_{max_c1_in} and P_{max_c2_in}, respectively. Suppose the maximum allowable total input power of the portable energy storage device (P_{max_in}) is 120 W, the maximum allowable charging power of the first power input port 101 (P_{max_c1_in}) is 50 W, and the maximum allowable charging power of the second power input port 102 (P_{max_c2_in}) is 60 W. Since the sum of P_{max_c1_in} and P_{max_c2_in} is 110 W, which is less than P_{max_in} (i.e., 120 W), the power allocation unit 201 configures the first power input port 101 to operate at P_{max_c1_in} (50 W) and the second power input port 102 to operate at P_{max_c2_in} (60 W).
2. When the sum of the maximum allowable charging power of all connected power input ports exceeds P_{max_in}, the power allocation unit 201 is configured with the power input ports in P_{max_in} as the sum of the operating powers. For example:
(1) When only one power input port is connected to a charging device, suppose the maximum allowable charging power of this port is 120 W, while the maximum allowable total input power of the portable energy storage device (P_{max_in}) is 100 W. Since the port's maximum allowable charging power exceeds P_{max_in}, the power allocation unit 201 configures this power input port to operate at P_{max_in}, i.e., 100 W.
(2) When two power input ports are connected to charging devices, suppose the maximum allowable total input power of the portable energy storage device (P_{max_in}) is 120 W, the maximum allowable charging power of the first power input port 101 (P_{max_c1_in}) is 70 W, and that of the second power input port 102 (P_{max_c2_in}) is 60 W. Since the sum of P_{max_c1_in} and P_{max_c2_in} is 130 W, which exceeds P_{max_in} (i.e., 120 W), the power allocation unit 201 configures the first power input port 101 and the second power input port 102 so that their total operating power is limited to P_{max_in}, i.e., 120 W.

By applying these power limitations to the power input ports, the system ensures that the total operating power of all power input ports remains within P_{max_in} while maximizing the input power.

Furthermore, for the charging output ports:
1. When the sum of the preset power values of all connected charging output ports does not exceed P_{max_out}, the power allocation unit assigns each charging output port its corresponding preset power. The preset power is defined as the smaller value between the maximum output power of the charging output port and the load request power. The load request power refers to the power required by the connected powered device under normal operation, which varies depending on the type of powered device. The maximum output power refers to the highest power that the charging output port is allowed to supply, which is pre-configured. For example:
(1) When a single charging output port is connected to a powered device: Suppose the maximum total output power of the portable energy storage device (P_{max_out}) is 100 W. The load request power of this charging output port is 100 W, and its maximum output power is 50 W. Since the load request power exceeds the maximum output power (100 W>50 W), the preset power of the port is its maximum output power, i.e., 50 W. As the preset power (50 W) is less than P_{max_out}, the power allocation unit assigns 50 W to this charging output port. Further: Suppose P_{max_out} remains 100 W, The load request power of the charging output port is 50 W and its maximum output power is also 50 W. Since the load request power equals the maximum output power, the preset power is 50 W. As the preset power (50 W) is less than P_{max_out}, the power allocation unit assigns 50 W to this charging output port.
(2) When two charging output ports are connected to powered devices: Suppose one charging output port has a preset power of 50 W and the other has a preset power of 100 W. The maximum total output power of the portable energy storage device (P_{max_out}) is 200 W. Since the sum of the preset power values of both ports (50 W+100 W=150 W) is less than P_{max_out}, the power allocation unit assigns each charging output port its respective preset power, i.e., 50 W and 100 W.
2. When the sum of the preset power values of all connected charging output ports exceeds P_{max_out}, the power allocation unit assigns a total power of P_{max_out} to these charging output ports.
(1) When a single charging output port is connected to a powered device: Suppose the maximum total output power of the portable energy storage device (P_{max_out}) is 100 W. The load request power of this charging output port is 150 W, and its maximum output power is 120 W. Since the load request power exceeds the maximum output power, the preset power of the port is its maximum output power, i.e., 120 W. As the preset power (120 W) is greater than P_{max_out}, the power allocation unit assigns P_{max_out}, i.e., 100 W, to this charging output port.
(2) When two charging output ports are connected to powered devices: Suppose one charging output port has a preset power of 150 W, and the other has a preset power of 100 W. The maximum total output power of the portable energy storage device (P_{max_out}) is 200 W. Since the sum of the preset power values of both ports (150 W+100 W=250 W) exceeds P_{max_out} (200 W), the power allocation unit 201 assigns a total power of P_{max_out}, i.e., 200 W, to these two charging output ports.

By implementing these power limitations on the charging output ports, the system ensures that the total assigned power does not exceed P_{max_out}, thereby maximizing output while maintaining safe operation.

The portable energy storage device provided in this embodiment supports simultaneous multi-port charging and discharging. By restricting the maximum allocated power for both power input ports and charging output ports, it ensures safe operation under simultaneous charging and discharging conditions. Moreover, by configuring power distribution for the input and output ports, this embodiment not only maintains safety but also enables the power input ports and charging output ports to achieve maximum input and maximum output, respectively.

### Embodiment 2

This embodiment provides a portable energy storage device capable of simultaneous multi-port charging and discharging, which is essentially the same as the portable energy storage device described in Embodiment 1. The difference lies in the further elaboration of the power allocation rules for the power input ports, particularly in scenarios where the sum of the maximum allowable charging power of the connected power input ports exceeds P_{max_in}. In such cases, the power allocation unit (201) configures the total operating power of these power input ports as P_{max_in}, and the rules for distributing power among them are specified.

For clarity and convenience in differentiation, the power input ports are labeled based on the number of connected charging devices: When only one power input port is connected to a charging device, it is defined as First Power Input Port 101. When two power input ports are connected, they are defined as First Power Input Port 101 and Second Power Input Port 102. When three power input ports are connected, they are defined as First Power Input Port 101, Second Power Input Port 102, and Third Power Input Port 103, and so on. Assuming N power input ports are connected to charging devices, the maximum allowable charging power of the First to the N-th Power Input Ports is denoted as P_{max_c1_in} to P_{max_cN_in}, respectively.

When external charging devices charge the portable energy storage device provided in this embodiment, and the sum of the maximum allowable charging power of the connected power input ports exceeds P_{max_in}, the power allocation unit (201) configures the total operating power of these ports as P_{max_in}, and:
(1) If the number of power input ports connected to charging devices is 1, the power allocation unit (201) configures this power input port to operate at P_{max_in} as the operating power.
(2) If the number of power input ports connected to charging devices is N, where N is a positive integer and N≥2:
\textcircled{1} If the maximum allowable charging power of each power input port is greater than P_{max_in}/N, the power allocation unit (201) configures all these power input ports to operate at P_{max_in}/N as the operating power.
\textcircled{2} If some of the N power input ports have a maximum allowable charging power less than or equal to P_{max_in}/N, for these power input ports, the power allocation unit (201) performs the first power configuration to make these power input ports operate at their maximum allowable charging power. Suppose the total power occupied by these ports is B₁, then the remaining power that the power allocation unit (201) can allocate is P₁=P_{max_in}−B₁, and the number of remaining unallocated power input ports is M₁=N−the number of power input ports configured to operate at their maximum allowable charging power in the first configuration. For the remaining M₁ power input ports:
a. If the maximum allowable charging power of these ports is greater than P₁/M₁, the power allocation unit (201) configures all the remaining M₁ power input ports to operate at P1M1 as the operating power.
b. If there are still some power input ports with maximum allowable charging power less than or equal to P₁/M₁, the power allocation unit (201) configures the power according to the following rule (in this rule, after the k-th power configuration, the total power occupied by the power input ports that operate at their maximum allowable charging power is Bₖ, and the remaining power that the power allocation unit (201) can allocate is Pₖ, while the number of remaining unallocated power input ports is Mx, where k is a positive integer and k≥1:

For the remaining Mx power input ports, if the maximum allowable charging power is less than or equal to PR/MR, the power allocation unit (201) performs the k+1-th power configuration to make these power input ports operate at their maximum allowable charging power. Suppose the total power occupied by these ports is Bₖ₊₁, the remaining power that the power allocation unit (201) can allocate is Pₖ₊₁=P_{max_in}−B₁ . . . Bₖ₊₁, and the number of remaining unallocated power input ports is Mₖ₊₁=Mₖ−the number of power input ports configured to operate at their maximum allowable charging power in the k+1-th configuration. In this rule, after the k+1-th power configuration, when the maximum allowable charging power of all the remaining Mₖ₊₁ power input ports is greater than Pₖ₊₁/Mₖ₊₁, the rule terminates, and the power allocation unit (201) configures all the remaining Mₖ₊₁ power input ports to operate at Pₖ₊₁/Mₖ₊₁ as the operating power.

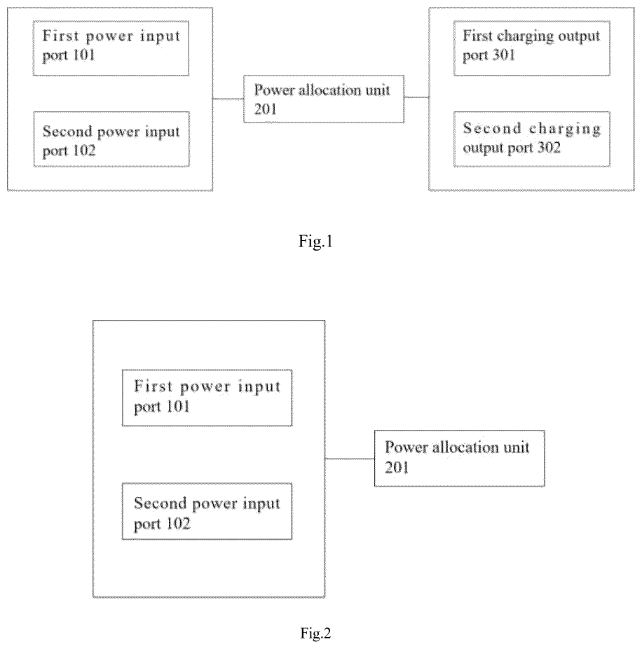

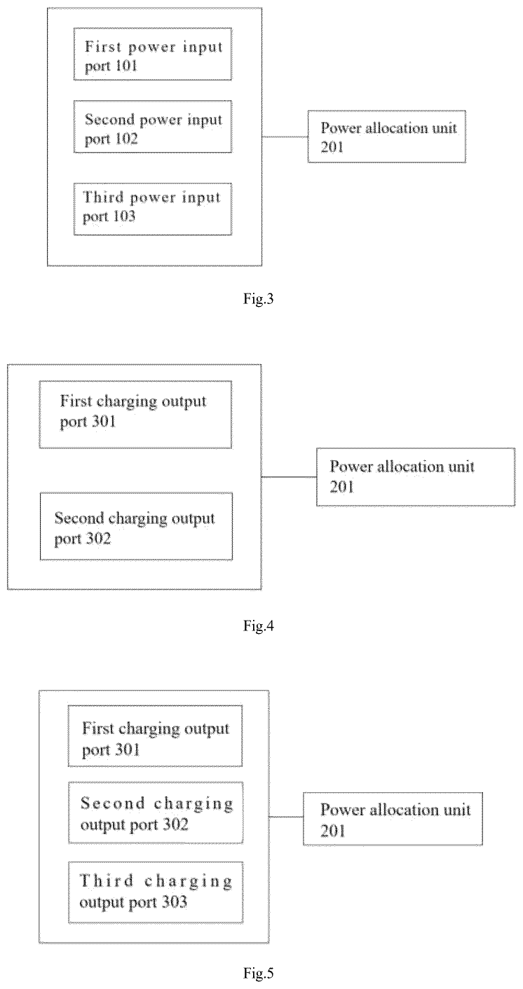

To enhance the understanding of the technical solution provided in this embodiment, the specific number of power input ports connected to charging devices is limited as follows:
1. If only the first power input port (101) is connected to a charging device, the power allocation unit (201) configures the first power input port (101) to operate at P_{max_in} as the operating power. For example, if the maximum allowable input power of the portable energy storage device P_{max_in} is 120 W, and the maximum allowable charging power of the first power input port (101), which is connected to a charging device, P_{max_c1_in} is 130 W, since P_{max_c1_in}>P_{max_in}, the power allocation unit (201) configures the first power input port (101) to operate at P_{max_in}, i.e., 120 W.
2. When the number of power input ports connected to charging devices is N, and the maximum allowable charging power of each power input port is greater than P_{max_in}/N, then:
(1) When N=2, as shown in FIG. 2, meaning that the first power input port (101) and the second power input port (102) are both connected to charging devices, and their maximum allowable charging power is greater than P_{max_in}/2, the power allocation unit (201) configures both the first power input port (101) and the second power input port (102) to operate at P_{max_in}/2. For example, if the maximum allowable input power of the portable energy storage device P_{max_in} is 120 W, the maximum allowable charging power of the first power input port (101) P_{max_c1_in} is 70 W, and the maximum allowable charging power of the second power input port (102) P_{max_c2_in} is 80 W, since both P_{max_c1_in} and P_{max_c2_in} are greater than P_{max_in}/2, which is 60 W, the power allocation unit (201) configures both the first power input port (101) and the second power input port (102) to operate at 60 W.
(2) When N=3, as shown in FIG. 3, meaning that the first power input port (101), second power input port (102), and third power input port (103) are all connected to charging devices, and their maximum allowable charging power is greater than P_{max_in}/3, the power allocation unit (201) configures all three ports (101, 102, and 103) to operate at P_{max_in}/3. For example, if the maximum allowable input power of the portable energy storage device P_{max_in} is 120 W, the maximum allowable charging power of the first power input port (101) P_{max_c1_in} is 70 W, the second power input port (102) P_{max_c2_in} is 80 W, and the third power input port (103) P_{max_c3_in} is 90 W, since P_{max_c1_in}, P_{max_c2_in}, and P_{max_c3_in} are all greater than P_{max_in}/3, which is 40 W, the power allocation unit (201) configures the first power input port (101), second power input port (102), and third power input port (103) to each operate at P_{max_in}/3, i.e., 40 W.
3. When the number of power input ports connected to charging devices is N, and the maximum allowable charging power of some power input ports is ≤P_{max_in}/N, then:
(1) When N=2, as shown in FIG. 2, meaning that the first power input port (101) and second power input port (102) are connected to charging devices, if the maximum allowable charging power of one of the power input ports is ≤P_{max_in}/2, then the power allocation unit (201) performs the first power allocation, setting that power input port to operate at its maximum allowable charging power. Assuming that the p ower occupied by this input port is B₁, the remaining allocatable power is calculated as: P₁=P_{max_in}−B₁, the number of remaining power input ports yet to be allocated power is: M₁=N−(number of power input ports configured to run at max allowable charging power)=2−1=1. For this remaining power input port, since its maximum allowable charging power plus B₁ exceeds P_{max_in}, it must be greater than P_{max_in}−B₁ (i.e., greater than P₁). Consequently, its maximum allowable charging power must also be greater than P₁/M₁. Therefore, the power allocation unit (201) sets the remaining power input port to operate at P₁/M₁, which simplifies to P₁.

For example, when the maximum allowable input power (P_{max_in}) of the portable energy storage device is 120 W, the maximum allowable charging power of the first power input port (P_{max_c1_in}) is 50 W, and the maximum allowable charging power of the second power input port (P_{max_c2_in}) is 80 W, the sum of P_{max_c1_in} and P_{max_c2_in} is 130 W, which exceeds P_{max_in} (120 W). Thus, the power allocation unit (201) ensures that the total operating power allocated to the first and second power input ports does not exceed 120 W. Since the maximum allowable charging power of the first power input port (101) is 50 W, which is less than P_{max_in}/2 (i.e., 60 W), the power allocation unit (201) performs the first power allocation, setting the first power input port (101) to operate at its maximum allowable charging power (P_{max_c1_in}=50 W). The power occupied by the first power input port (B₁) is therefore 50 W, and the remaining allocatable power is calculated as: P₁=Pₘₐₓᵢₙ−B₁=120 W−50 W=70 W, the number of remaining power input ports yet to be allocated power is: M₁=2−(number of ports allocated at max allowable power)=2−1=1. For the remaining power input port (i.e., second power input port 102), since its maximum allowable charging power (P_{max_c2_in}=80 W) is greater than P₁/M₁=70 W, the power allocation unit (201) configures the second power input port (102) to operate at 70 W.
(2) When N=3, as shown in FIG. 3, i.e., when the first power input port (101), second power input port (102), and third power input port (103) are all connected to charging devices:
\textcircled{1} If the maximum allowable charging power of two of the power input ports is ≤P_{max_in}/3, the power allocation unit (201) performs the first power allocation, setting these two power input ports to operate at their maximum allowable charging power. Assuming the total power occupied by these two power input ports is B₁, the remaining allocatable power is: P₁=Pₘₐₓᵢₙ−B₁. The number of remaining power input ports yet to be allocated power is: M₁=3−(number of ports allocated at max allowable power)=3−2=1. For the remaining one power input port, since its maximum allowable charging power plus B₁ is greater than P_{max_in}, it must be greater than P_{max_in}−B₁ (i.e., greater than P₁). Thus, its maximum allowable charging power is greater than P₁/M₁ (which equals P₁), so the power allocation unit (201) configures the remaining power input port to operate at P₁/M₁ (i.e., P₁).

For example, when the maximum allowable input power P_{max_in} of the portable energy storage device is 120 W, the maximum allowable charging power of the first power input port 101 (P_{max_c1_in}) is 30 W, the second power input port 102 (P_{max_c2_in}) is 40 W, and the third power input port 103 (P_{max_c3_in}) is 60 W. Since the sum of P_{max_c1_in}, P_{max_c2_in}, and P_{max_c3_in} is 130 W, which exceeds P_{max_in} (i.e., 120 W), the power allocation unit 201 configures the combined operating power of the three power input ports to be 120 W. Since the maximum allowable charging power of the first power input port 101 and the second power input port 102 is 30 W and 40 W, respectively, both of which are within the range of ≤P_{max_in}/3 (i.e., 40 W), the power allocation unit 201 performs the first power allocation, setting the first power input port 101 and the second power input port 102 to operate at their respective maximum allowable charging power, P_{max_c1_in} and P_{max_c2_in}, which are 30 W and 40 W, respectively. The total power occupied by the first and second power input ports (B₁) is 70 W. The remaining power available for allocation by the power allocation unit 201 is P₁=P_{max_in}−B₁=120 W−70 W=50. The number of power input ports yet to be allocated is M₁=3−(number of power input ports allocated at maximum allowable charging power in the first allocation)=3−2=1. For the remaining power input port, i.e., the third power input port 103, since its maximum allowable charging power P_{max_c3_in} is 60 W, which is greater than P₁/M₁ (i.e., 50 W), the power allocation unit 201 configures the third power input port 103 to operate at 50 W.
\textcircled{2} If only one of the power input ports has a maximum allowable charging power≤P_{max_in}/3, the power allocation unit 201 performs the first power allocation, setting that power input port to operate at its maximum allowable charging power. Assuming the total power occupied by this power input port is B₁, the remaining power available for allocation by the power allocation unit 201 is P₁=P_{max_in}−B₁. The number of power input ports yet to be allocated is M₁=3−(number of power input ports allocated at maximum allowable charging power in the first allocation)=3−1=2. For the remaining two power input ports, if their maximum allowable charging power is greater than P₁/M₁, the power allocation unit 201 configures them to operate at P₁/M₁. However, if one of the remaining power input ports has a maximum allowable charging power≤P₁/M₁, the power allocation unit 201 performs a second power allocation, setting that power input port to operate at its maximum allowable charging power. Assuming the total power occupied by this power input port is B₂, the remaining power available for allocation by the power allocation unit 201 is P₂=P_{max_in}−B₁−B₂. The number of power input ports yet to be allocated is M₂=M₁−(number of power input ports allocated at maximum allowable charging power in the second allocation)=2−1=1. Since the remaining power input port's maximum allowable charging power plus B₁+B₂ exceeds P_{max_in}, it must be greater than P_{max_in}−B₁−B₂ (i.e., greater than P₂). Therefore, its maximum allowable charging power is greater than P₂/M₂ (i.e., P₂), and the power allocation unit 201 configures the remaining power input port to operate at P₂/M₂, which is P₂.

For example, when the maximum allowable input power P_{max_in} of the portable energy storage device is 120 W, the maximum allowable charging power of the first power input port 101 (P_{max_c1_in}) is 30 W, the second power input port 102 (P_{max_c2_in}) is 50 W, and the third power input port 103 (P_{max_c3_in}) is 60 W. Since the sum of P_{max_c1_in}, Pₘₐₓ 2 in, and P_{max_c3_in} is 140 W, which exceeds P_{max_in} (i.e., 120 W), the power allocation unit 201 configures the combined operating power of all three power input ports to be 120 W. Since only the first power input port 101 has a maximum allowable charging power of 30 W, which is less than P_{max_in}/3 (i.e., 40 W), the power allocation unit 201 performs the first power allocation, setting the first power input port 101 to operate at its maximum allowable charging power P_{max_c1_in}, which is 30 W. The total power occupied by the first power input port 101 is B₁=30 W, leaving the remaining power available for allocation as P₁=P_{max_in}−B₁=120 W−30 W−90 W. The number of power input ports yet to be allocated is M₁=3−(number of power input ports allocated at maximum allowable charging power in the first allocation)=3−1=2. For the remaining two power input ports, the maximum allowable charging power of the second power input port 102 (P_{max_c2_in}) is 50 W, and the third power input port 103 (P_{max_c3_in}) is 60 W. Since both are greater than P₁/M₁=45 W, the power allocation unit 201 configures both the second power input port 102 and the third power input port 103 to operate at P₁/M₁, which is 45 W.

For example, when the maximum allowable input power P_{max_in} of the portable energy storage device is 120 W, the maximum allowable charging power of the first power input port 101 (P_{max_c1_in}) is 30 W, the second power input port 102 (P_{max_c2_in}) is 45 W, and the third power input port 103 (P_{max_c3_in}) is 60 W. Since the sum of P_{max_c1_in}, P_{max_c2_in}, and P_{max_c3_in} is 135 W, which exceeds P_{max_in} (i.e., 120 W), the power allocation unit 201 configures the combined operating power of all three power input ports to be 120 W. Since the maximum allowable charging power of the first power input port 101 is 30 W, which is less than P_{max_in}/3 (i.e., 40 W), the power allocation unit 201 performs the first power allocation, setting the first power input port 101 to operate at its maximum allowable charging power P_{max_c1_in}, which is 30 W. The total power occupied by the first power input port 101 is B₁=30 W, leaving the remaining power avail able for allocation as P₁=P_{max_in}−B₁=120 W−30 W−90 W. The number of power input ports yet to be allocated is M₁=3−(number of power input ports allocated at maximum allowable charging power in the first allocation)=3−1=2. For the remaining two power input ports, the maximum allowable charging power of the second power input port 102 (P_{max_c2_in}) is 45 W, which is within the ≤P₁/M₁ (i.e., 45 W) range. Therefore, the power allocation unit 201 performs the second power allocation, setting the second power input port 102 to operate at its maximum allowable charging power P_{max_c2_in}, which is 45 W. The total power occupied by the second power input port 102 is B₂=45 W, leaving the remaining power available for allocation as P₂=P_{max_in}−B₁−B₂=120 W−30 W−45 W=45 W. The number of power input ports yet to be allocated is M₂=M₁−(number of power input ports allocated at maximum allowable charging power in the second allocation)=2−1=1. Since the maximum allowable charging power of the third power input port 103 is 60 W, which is greater than P₂/M₂ (i.e., P₂=45 W), the power allocation unit 201 configures the third power input port 103 to operate at 45 W.

The above provides the power distribution rules for the portable energy storage device provided in this embodiment when the number of power input ports connected to the charging device is 1, 2, or 3. Those skilled in the art, based on the above examples, can further deduce the relevant power distribution rules when the number of power input ports connected to the charging device is different, which will not be elaborated here.

The portable energy storage device provided in this embodiment, through further limiting the power distribution rules of the power input ports, achieves the following technical effects: The power input ports can be used one at a time or simultaneously. When used one at a time, by comparing the size relationship between the maximum allowable input power of the storage device and the maximum allowable charging power of the ports, the storage device can achieve the maximum charging power input while ensuring safety. When multiple power input ports are used simultaneously, through the aforementioned power distribution logic, it ensures that each power input channel operates in a balanced manner, avoiding situations where one channel operates at high power while others work at very low power or do not work at all, which would concentrate internal heat in one area. This improves the safety of the portable energy storage device during charging and extends its lifespan. Furthermore, this design allows multiple charging devices to share power more evenly, thus avoiding the operation of charging devices at full load and significantly extending the lifespan of the charging devices.

### Embodiment 3

This embodiment provides a portable energy storage device capable of simultaneous multi-port charging and discharging, which is essentially the same as the portable energy storage device provided in Embodiment 1. The difference lies in the further elaboration of the power distribution rules for the charging output ports, especially when the sum of the preset powers of the charging output ports connected to the receiving device exceeds P_{max_out}. In this case, the power distribution rules for these charging output ports are as follows, where the power allocated to these charging output ports by the power allocation unit 201 is limited to P_{max_out}.

In this embodiment, the charging output ports are pre-set with a priority order for power distribution. For the charging output ports with higher priority, the power allocation unit 201 will prioritize meeting the required power for those charging output ports when performing power distribution. Each charging output port is pre-set with a minimum output power and a maximum output power. The sum of the pre-configured minimum output powers of the charging output ports is ≤P_{max_out}, and the minimum output power of each charging output port is ≤the maximum output power of that port. The maximum output power of each charging output port is ≤P_{max_out}. The number of charging output ports connected to the receiving device is defined as Y. Since the maximum output power of each charging output port is ≤P_{max_out}, in the case where the sum of the preset powers of the charging output ports connected to the receiving device exceeds P_{max_out}, it follows that Y≥2.

1. When the Y charging output ports have different priorities:

The charging output ports are sorted in order of priority from high to low, with the sequence defined as the first charging output port 301 to the Y-th charging output port. Their minimum output power is defined sequentially as P_{min_c1} to P_{min_cY}, and the smaller value between the maximum output power and load request power is defined as the first preset power to the Y-th preset power.

If P_{max_out}=(P_{min_c1}+ . . . +P_{min_cY}), meaning the maximum output power of the portable energy storage device is equal to the sum of the minimum output powers of the charging output ports connected to the receiving device, the power allocation unit allocates each connected charging output port its corresponding minimum output power.

If (P_{min_c1}+ . . . +P_{min_cY})<P_{max_out}<(first preset power+ . . . +Y-th preset power), the power allocation unit first ensures the minimum output power for these charging output ports (i.e., the power allocation unit first allocates each charging output port its corresponding minimum output power). Then, the remaining power is allocated sequentially according to priority. The initial amount of remaining power is defined as P_{0_out}, where: P_{0_out}=P_{max_out}−(P_{min_c1}+ . . . +P_{min_cY}). The rules for allocating the remaining power are as follows:

During the first round of remaining power allocation, the power allocation unit assigns the first charging output port a total power equal to the smaller value between (P_{min_c1}+remaining power P_{0_out}) and the first preset power. Define the remaining power obtained by the first charging output port after the first round of allocation as C₁: C₁=total power allocated to the first charging output port-P_{min_c1}. Define the remaining power after the first round of allocation as P_{1_out}: P_{1_out}=P_{0_out}−C₁. If P_{1_out}=0, the power allocation process ends. If P_{1_out}>0, the remaining power continues to be allocated according to the following rule until P_{k_out}=0, at which point the power allocation process concludes: In the k-th round of remaining power allocation, the power allocation unit assigns the k-th charging output port a total power equal to the smaller value between (P_{min_ck}+remaining power P_{(k-1)_out}) and the k-th preset power. Define the remaining power obtained by the k-th charging output port after the k-th round as Cₖ: Cₖ=total power allocated to the k-th charging output port−P_{min_ck}. Define the remaining power after the k-th round of allocation as P_{k_out}: P_{k_out}=P_{0_out}−C₁− . . . −Cₖ, where k is a positive integer and k≥2.

It can be understood that when Y=2, meaning two charging output ports with different priority levels are connected to the receiving devices, as shown in FIG. 4, these two charging output ports are sequentially defined as the first charging output port 301 and the second charging output port 302, in descending order of priority. Their minimum output power values are defined as P_{min_c1} and P_{min_c2}, respectively, while the smaller value between their maximum output power and the load request power is defined as the first preset power and the second preset power, respectively.

If P_{max_out}=(P_{min_c1}+P_{min_c2}), then the power allocation unit 201 assigns power to the first charging output port 301 and the second charging output port 302 according to their respective minimum output power values.

If (P_{min_c1}+P_{min_c2})<P_{max_out}<(First Preset Power+Second Preset Power), the power allocation unit 201 first ensures that the first charging output port 301 and the second charging output port 302 receive their respective minimum output power. Then, the remaining power is allocated sequentially according to priority. The initial amount of remaining power is defined as: P_{0,out}=P_{max_out}−(P_{min_c1}+P_{min_c2}). The allocation rules are as follows:

During the first round of remaining power allocation, the power allocation unit 201 assigns the total power obtained by the first charging output port 301 as the smaller value between (P_{min_c1}+P_{0,out}) and the first preset power. After the first round of remaining power allocation: The additional power obtained by the first charging output port 301 is: C₁=Total power allocated to the first charging output port 301−P_{min_c1}, The remaining power after the first allocation is: P_{1,out}=P_{0,out}−C₁. If P_{1_out}=0, the power allocation process ends. This means the total power allocated to the first charging output port 301 is (P_{min_c1}+P_{0_out}), while the total power allocated to the second charging output port 302 remains at its minimum output power.

If P_{1_out}>0, it indicates that the first charging output port 301 has reached its first preset power, and there is still remaining power available for further allocation to the second charging output port 302. Therefore, a second round of remaining power allocation is performed. At this stage, the power allocation unit 201 assigns the total power obtained by the second charging output port 302 as the smaller value between (P_{min_c2}+P_{1_out}) and the second preset power. It can be understood that, since P_{max_out}<(First Preset Power+Second Preset Power), it follows that (P_{min_c2}+P_{1_out}) must be less than the second preset power. Therefore, the power allocation unit 201 directly assigns the remaining power P1out to the second charging output port 302, ensuring that its total allocated power is (P_{min_c2}+P_{1_out}). Since, after the second round of remaining power allocation, the additional power received by the second charging output port 302 is: C 2=Total power allocated to the second charging output port 302−P_{min_c2}=P_{1_out}. The remaining power after the second allocation is: P_{2_out}=P_{0_out}−C₁−C₂=0. At this point, the power allocation process ends. This means that the first charging output port 301 receives its first preset power, while the second charging output port 302 receives (P_{min_c2}+P_{1_out}).

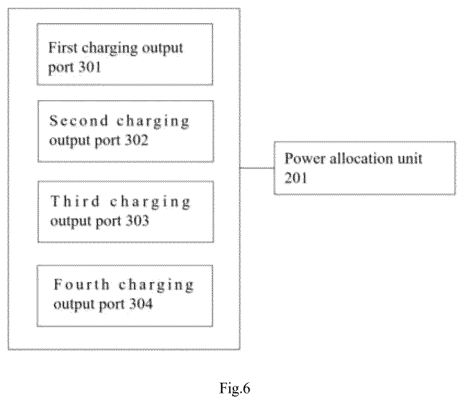

Accordingly, when Y=3, meaning that three charging output ports with different priority levels are connected to the powered devices, as shown in FIG. 5, the charging output ports are sequentially defined in order of priority from highest to lowest as the first charging output port 301, the second charging output port 302, and the third charging output port 303. Their respective minimum output powers are defined as P_{min_c1}, P_{min_c2}, and P_{min_c3}. The smaller value between their maximum output power and the requested load power is defined as the first preset power, the second preset power, and the third preset power, respectively.

If P_{max_out}=(P_{min_c1}+P_{min_c2}+P_{min_c3}), then the power allocation unit 201 assigns the first, second, and third charging output ports 301, 302, and 303 their respective minimum output power.

If (P_{min_c1}+P_{min_c2}+P_{min_c3})<P_{max_out}<First Preset Power+Second Preset Power+Third Preset Power), then the power allocation unit 201 first ensures the minimum output power for each charging output port. Subsequently, the remaining power is distributed sequentially according to priority. The initial remaining power is defined as: P₀ₒᵤₜ=P_{max_out}−(P_{min_c1}+P_{min_c2}+P_{min_c3}), The distribution rules are as follows:

During the first round of remaining power distribution, the power allocation unit 201 assigns the total power to the first charging output port 301 based on the smaller value between (P_{min_c1}+P_{0_out}) and the first preset power. After the first round of distribution: The additional power received by the first charging output port 301 is calculated as: C₁=Total power assigned to the first charging output port 301−P_{min_c1}. The remaining power after this round is: P_{1_out}=P_{0_out}−C₁. If P_{1_out}=0, the power allocation proc ess ends. This means: the first charging output port 301 receives a total power of (P_{min_c1}+P_{0_out}). The second charging output port 302 and the third charging output port 303 receive only their respective minimum output power.

If P_{1_out}>0, it means that the first charging output port 301 has reached the first preset power, and there is still remaining power available to be further allocated to the second charging output port 302. Therefore, a second round of remaining power distribution takes place. In this round, the power allocation unit 201 assigns the total power to the second charging output port 302 based on the smaller value between (P_{min_c2}+P_{1_out}) and the second preset power. After the second round of distribution: The additional power received by the second charging output port 302 is calculated as: C₂=Total power assigned to the second charging output port 302−P_{min_c2}. The remaining power after this round is: P_{2_out}=P_{0_out}−C₁−C₂. If P_{2_out}=0, the power allocation process ends. This means: The first charging output port 301 receives a total power of the first preset power. The second charging output port 302 receives a total power of (P_{min_c2}+P_{1_out}). The third charging output port 303 receives only its minimum output power.

If P_{2_out}>0, it indicates that the second charging output port 302 has reached the s second preset power, and there is still remaining power that can be further allocated to the third charging output port 303. Therefore, a third round of remaining power distribution occurs. In this round, the power allocation unit 201 assigns the total power to the third charging output port 303 based on the smaller value between (P_{min_c3}+P_{2_out}) and the third preset power. Since P_{max_out}<(First preset power+Second preset power+Third preset power), (P_{min_c3}+P_{2_out}) is always less than the third preset power. Therefore, the power allocation unit 201 directly allocates the remaining power P_{2_out} to the third charging output port 303, ensuring the total power allocated to the third charging output port 303 is (P_{min_c3}+P_{2_out}). After the third round of remaining power distribution: The remaining power allocated to the third charging output port 303 is: C₃=Total power assigned to the third charging output port 303−P_{min_c3}=P_{2_out}. The remaining power after this round is: P_{3_out}=P_{0_out}−C₁−C₂−C₃=0. The remaining power distribution ends. This means: The first charging output port 301 receives a total power of the first preset power. The second charging output port 302 receives a total power of the second preset power. The third charging output port 303 receives a total power of (P_{min_c3}+P_{2_out}).

When Y takes other values, those skilled in the art can deduce the corresponding power distribution based on the descriptions above.

The following section substitutes specific numerical values to further elaborate on the power distribution rules when charging output ports have different priorities, there by enhancing the understanding of the technical solution in this embodiment.

(1) When Y=2, according to the priority order of the charging output ports connected to the powered devices, these two charging output ports are defined as the first charging output port 301 and the second charging output port 302. The following presets are made as shown in Table 1:

TABLE 1

| | First charging | Second charging |
|---|---|---|
| Relevant Parameters | output port 301 | output port 302 |
| Minimum Output Power Pₘᵢₙ | 20 W | 30 W |
| Maximum Output Power Pₘₐₓ | 40 W | 50 W |
| Load Request Power | 30 W | 60 W |
| Preset Power | 30 W | 50 W |

Assuming P_{max_out}=100 W, since P_{max_out}>(First Preset Power+Second Preset Power), the power allocation unit 201 assigns power to the first and second charging output ports (301 and 302) according to their preset power. That is, the first charging output port 301 receives 30 W, and the second charging output port 302 receives 50 W.

Assuming P_{max_out}=50 W, since P_{max_out}=(P_{min_c1}+P_{min_c2}), the power allocation unit 201 assigns power to the first and second charging output ports (301 and 302) according to their minimum output power. That is, the first charging output port 301 receives 20 W, and the second charging output port 302 receives 30 W.

Assuming P_{max_out}=55 W, since (P_{min_c1}+P_{min_c2})<P_{max_out}<(First Preset Power+Second Preset Power), the power allocation unit 201 first satisfies the minimum output power requirements of the first and second charging output ports 301 and 302. That is, power is initially allocated based on their minimum output power values. The remaining power after this allocation is calculated as: P_{0_out}=P_{max_out}−(P_{min_c1}+P_{min_c2})=55 W−50 W=5 W, the distribution rules for this remaining 5 W of power are as follows:

In the first round of remaining power allocation, the power allocation unit 201 as signs the total power to the first charging output port 301 based on the smaller value between (P_{min_c1}+P_{0_out}) and the first preset power. Since P_{min_c1}+P_{0_out}=25 W, and the first preset power is 30 W, the power allocation unit 201 allocates 25 W as the total power for the first charging output port 301. The remaining power obtained by the first charging output port 301 is: C₁=Total allocated power for the first charging output port 301−P_{min_c1}=25 W−20 W=5 W. The remaining power after the first round of allocation is: P_{1_out}=P_{0_out}−C₁=5 W−5 W=0. Since P_{1_out}=0, the power allocation process ends. This means that the total allocated power for the first charging output port 301 is P_{min_c1}+P_{0_out}=25 W, while the total allocated power for the second charging output port 302 remains its minimum output power, i.e., 30 W.

Since (P_{min_c1}+P_{min_c2})<P_{max_out}<(first preset power+second preset power), the power allocation unit 201 first satisfies the minimum output power requirements of the first and second charging output ports (301 and 302). At this point, the remaining power is calculated as: P_{0_out}=P_{max_out}−(P_{min_c1}+P_{min_c2})=70 W−50 W=20 W. The distribution rule for this 20 W of remaining power is as follows:

Performing the first round of remaining power allocation, the power allocation unit 201 assigns the total power obtained by the first charging output port 301 as the smaller value between (P_{min_c1}+P_{0_out}) and the first preset power. Since P_{min_c1}+P_{0_out}=40 W and the first preset power is 30 W, the power allocation unit 201 assigns 30 W to the first charging output port 301. The remaining power obtained by the first charging output port 301 is: C₁=The total power allocated to the first charging output port 301−P_{min_c1}=30 W−20 W=10 W. After the first round of remaining power allocation, the remaining power is: P_{1_out}=P_{0_out}−C₁=20 W−10 W=10 W. Since P_{1_out}>0, a second round of remaining power allocation is performed. At this stage, the power allocation unit 201 assigns the total power obtained by the second charging output port 302 as the smaller value between (P_{min_c2}+P_{1_out}) and the second preset power.

Since P_{max_out}<(first preset power+second preset power), it follows that (P_{min_c2}+remaining_power P_{1_out}) is necessarily less than the second preset power. (Note: P_{min_c2}+remaining_power P_{1_out}=40 W, and the second preset power is 50 W). Therefore, the power allocation unit 201 directly assigns the remaining power P_{1_out} (i.e., 10 W) to the second charging output port 302, so that the total power allocated to the second charging output port 302 is: P_{min_c2}+remaining_power_P_{1_out}=40 W.

After the second round of remaining power allocation, the remaining power C₂ obtained by the second charging output port 302 is: C₂=Total power allocated to second charging output port 302−P_{min_c2}=remaining_power P_{1_out}=10 W. The remaining power after the second round of allocation is: P_{2_out}=P_{0_out}−C₁−C₂=20 W−10 W−10 W=0. Since P_{2_out}=0, the remaining power allocation ends. This means that: the total power allocated to the first charging output port 301 is its first preset power, i.e., 30 W. The total power allocated to the second charging output port 302 is P_{min_c2}+P_{1_out}, i.e., 40 W.

(2) When Y=3, according to the priority order of the charging output ports connected to the receiving equipment, these 3 charging output ports are defined as the first charging output port 301, the second charging output port 302, and the third charging output port 303, with the following presets as shown in Table 2:

TABLE 2

| | First charging | Second charging | Third charging |
|---|---|---|---|
| Relevant Parameters | output port 301 | output port 302 | output port 302 |
| Minimum Output | 20 W | 30 W | 40 W |
| Power Pₘᵢₙ | | | |
| Maximum Output | 40 W | 50 W | 100 W |
| Power Pₘₐₓ | | | |
| Load Request Power | 30 W | 60 W | 100 W |
| Preset Power | 30 W | 50 W | 100 W |

Assume P_{max_out}=180 W, since P_{max_out}=(first preset power+second preset power+third preset power), the power allocation unit 201 assigns the following powers to the first, second, and third charging output ports (301, 302, and 303), respectively, based on their preset powers. That is, the power allocated to the first charging output port 301 is 30 W, the power allocated to the second charging output port 302 is 50 W, and the power allocated to the third charging output port 303 is 100 W.

Assume P_{max_out}=90 W, since P_{max_out}=(P_{min_c1}+P_{min_c2}+P_{min_c3}), the power allocation unit 201 assigns the following powers to the first, second, and third charging output ports (301, 302, and 303), respectively, based on their minimum output powers. That is, the power allocated to the first charging output port 301 is 20 W, the power allocated to the second charging output port 302 is 30 W, and the power allocated to the third charging output port 303 is 40 W.

Assume P_{max_out}=150 W, since (P_{min_c1}+P_{min_c2}+P_{min_c3})<P_{max_out}<(first preset power+second preset power+third preset power), the power allocation unit 201 first satisfies the minimum output power requirements for the first, second, and third charging output ports (301, 302, and 303). At this point, the remaining power P_{0_out}=P_{max_out}−(P_{min_c1}+P_{min_c2}+P_{min_c3})=150 W−90 W=60 W. The distribution rule for this remaining 60 W of power is as follows:

In the first round of remaining power allocation, the power allocation unit 201 as signs the total power obtained by the first charging output port 301 as the smaller value between (P_{min_c1}+remaining power P_{0_out}) and the first preset power. Since (P_{min_c1}+remaining power P_{0_out})=80 W and the first preset power is 30 W, and the first preset power is smaller than (P_{min_c1}+remaining power P_{0_out}), the power allocation unit 201 assigns the first preset power of 30 W to the first charging output port 301. After the first round of remaining power allocation, the remaining power C₁ obtained by the first charging output port 301 is: C₁=total power allocated to the first charging output port 301−P_{min_c1}=30 W−20 W=10 W. After the first round of remaining power allocation, the remaining power is: P_{1_out}=P_{0_out}−C₁=60 W−10 W=50 W. Since P_{1_out}>0, the second round of remaining power allocation continues.

In the second round of remaining power allocation, the power allocation unit 201 assigns the total power obtained by the second charging output port 302 as the small er value between (P_{min_c2}+remaining power P_{1_out}) and the second preset power. Since (P_{min_c2}+remaining power P_{1_out})=80 W and the second preset power is 50 W, the power allocation unit 201 assigns the second preset power of 50 W to the second charging output port 302. After the second round of remaining power allocation, the remaining power C₂ obtained by the second charging output port 302 is: C₂=total power allocated to the second charging output port 302−P_{min_c2}=50 W−30 W=20 W. After the second round of remaining power allocation, the remaining power is: P_{2_out}=P_{0_out}−C₁−C₂=60 W−10 W−20 W=30 W. Since P_{2_out}>0, the third round of remaining power allocation continues.

In the third round of remaining power allocation, the power allocation unit 201 assigns the total power obtained by the third charging output port 303 as the smaller value between (P_{min_c3}+remaining power P_{2_out}) and the third preset power. Since (P_{min_c3}+remaining power P_{2_out})=70 W and the third preset power is 100 W, the power allocation unit 201 assigns (P_{min_c3}+remaining power P_{2_out}), i.e., 70 W, to the third charging output port 303. After the third round of remaining power allocation, the remaining power C₃ obtained by the third charging output port 303 is: C₃=total power allocated to the third charging output port 303−P_{min_c3}=70 W−40 W=30 W. After the third round of remaining power allocation, the remaining power is: P_{3_out}=P_{0_out}−C₁−C₂−C₃=60 W−10 W−20 W−30 W=0. Since P_{3_out}=0, the power allocation ends. This means that the total power allocated to the first and second charging output ports 301 and 302 is their respective preset power, i.e., 30 W and 50 W, and the total power allocated to the third charging output port 303 is (P_{min_c3}+remaining power P_{2_out}), i.e., 70 W.

2. When Y≥3, and among these Y charging output ports, x charging output ports have the same priority and are of the lowest priority, with Y>x≥2 (in this case, the remaining Y−x charging output ports have different priorities):

Sorted by priority from high to low, the charging output ports are defined in order from the first charging output port 301 to the Y-th charging output port, where the priority of the charging output ports from the (Y−x+1)-th to the Y-th is the same. Therefore, for these x charging output ports with the lowest priority, there is no restriction on their internal sequence. After sorting, the minimum output power of these charging output ports is defined in order as P_{min_c1} to P_{min_cY}, and their maximum output power and load request power are the smaller values between the respective first preset power and Y-th preset power.

If P_{max_out}=(P_{min_c1}+ . . . +P_{min_cY}), the power allocation unit assigns the corresponding minimum output power to each charging output port connected to the receiving device.

If (P_{min_c1}+ . . . +P_{min_cY})<P_{max_out}<(first preset power+ . . . +Y-th preset pow er), the power allocation unit 201 first satisfies the minimum output power for each of the charging output ports (i.e., the power allocation unit first assigns the corresponding minimum output power to each charging output port connected to the receiving de vice). Then, the remaining power is allocated sequentially based on priority. The initial amount of remaining power is defined as P_{0_out}, where: P_{0_out}=P_{max_out}−(P_{min_c1}+ . . . +P_{min_cY}). The allocation rule is as follows:

In the first round of remaining power allocation, the power allocation unit 201 as signs the total power obtained by the first charging output port 301 as the smaller value between (P_{min_c1}+remaining power P_{0_out}) and the first preset power. After the first round of remaining power allocation, the remaining power obtained by the first charging output port 301 is defined as C₁, where: C₁=Total power allocated to the first charging output port 301−P_{min_c1}. After the first round of remaining power allocation, the remaining power left is defined as P_{1_out}, where: P_{1_out}=P_{0_out}−C₁. If P_{1_out}=0,
then the power allocation ends. If P_{1_out}>0, and at this point, only x charging output ports have not yet been allocated remaining power, the power allocation unit 201 will distribute the remaining power P_{1_out} evenly across these x charging output ports, and the power allocation ends. If P_{1_out}>0 and the number of charging output ports that have not yet been allocated remaining power is greater than x, the power allocation unit 201 will continue the remaining power allocation according to the following remaining power distribution rules until one of the two conditions is met:

The remaining power allocation rule is as follows: In the k-th round of remaining power allocation, the power allocation unit 201 assigns the total power obtained by the k-th charging output port as the smaller value between (P_{min_ck}+remaining power P_{k-1_out}) and the k-th preset power. After the k-th round of remaining power allocation, the remaining power obtained by the k-th charging output port is defined as Cₖ, where: Cₖ=Total power allocated to the k-th charging output port-P_{min_ck}. The remaining power after the k-th round of allocation is defined as P_{k_out}, where: P_{k_out}=P_{0_out}−C₁− . . . −Cₖ;

The first condition is that the remaining power P_{k_out} is 0. The second condition is that the remaining power P_{k_out}>0 and the charging output ports from Y−x+1 to Y have not yet been allocated remaining power. If the first condition is met first, the power allocation process ends. If the second condition is met first, the remaining power P_{k_out} is evenly distributed among the charging output ports from Y−x+1 to Y, and the power allocation process ends. Here, k is a positive integer, and 2≤k≤Y−x.

3. When Y≥2 and among these Y charging output ports, there are xxx ports with the same priority level, which is the lowest priority level, and when Y=x, meaning a 11 Y charging output ports have the same lowest priority level, the power allocation unit first satisfies the minimum output power requirements of these charging output ports and then evenly distributes the remaining power.

To facilitate the understanding of the above technical solution, specific numerical examples are provided below for further explanation:

Assuming that the portable energy storage device is equipped with four charging output ports, designated as W port, A port, C1 port, and C2 port, their priority levels are set as follows: W port>A port>C1 port=C2 port. Therefore, as shown in FIG. 6, if defined in order, the W port is the first charging output port 301, the A port is the second charging output port 302, the C1 port is the third charging output port 303, and the C2 port is the fourth charging output port 304. When these four charging output ports are connected to powered devices, the relevant power data is shown in Table 3 below.

TABLE 3

| Relevant Parameters | W port | A port | C1 port | C2 port |
|---|---|---|---|---|
| Minimum Output Power Pmin | 20 W | 30 W | 50 W | 50 W |
| Maximum Output Power Pmax | 40 W | 50 W | 70 W | 70 W |
| Load Request Power | 30 W | 60 W | 80 W | 80 W |
| Preset Power | 30 W | 50 W | 70 W | 70 W |

\textcircled{1} If only the W port is connected to a powered device, the power allocation unit 201 assigns 30 W to the W port, as it is the smaller value between its maximum output power and load request power. Similarly, if only the C1 port is connected to a powered device, the power allocation unit 201 assigns 70 W to the C1 port, as it is the smaller value between its maximum output power and load request power.
\textcircled{2} If only the C1 and C2 ports are connected to powered devices, assuming P_{max_out}=110 W, and since P_{max_out} is less than the sum of the preset power of C1 and C2, the power allocation unit 201 first satisfies the minimum output power of C1 and C2. At this point, the remaining power is: Remaining power=P_{max_out}−(P_{min_C1}+P_{min_C2})=10 W. The power allocation unit 201 then distributes the remaining 10 W equally between the C1 and C2 ports. As a result, both C1 and C2 ultimately receive a total power of 55 W each.
3 If only the W, A, and C1 ports are connected to powered devices, assuming P_{max_out}=140 W, and since (P_{min_W}+P_{min_A}+P_{min_C1})<P_{max_out}<(W preset power+A preset power+C1 preset power). The power allocation unit 201 first satisfies the minimum output power requirements of the W, A, and C1 ports. Then, the remaining power is allocated sequentially based on priority. The initial amount of remaining power is defined as: P_{0_out}=P_{max_out}−(P_{min_W}+P_{min_A}+P_{min_C1})=140 W−100 W=40 W. The distribution rules are as follows:

During the first round of remaining power allocation, the power allocation unit 201 assigns the total power to the W port based on the smaller value between (P_{min_W}+P_{0_out}) and the W preset power. P_{min_W}+P_{0_out}=60 W, W preset power=30 W. Since the W preset power is smaller, the power allocation unit 201 assigns a total power of 30 W to the W port. After the first round of remaining power allocation: the additional power received by the W port is: C₁=total allocated power of W port−P_{min_W}=30 W−20 W=10 W. The remaining power after the first round is: P_{1_out}=P_{0_out}−C₁=40 W−10 W=30 W.

Since P_{1_out}>0, the second round of remaining power allocation continues. In this round, the power allocation unit 201 assigns total power to the A port based on the smaller value between (P_{min_A}+P_{1_out}) and the A preset power. Since (P_{min_A}+P_{1_out})=60 W and the A preset power is 50 W, the power allocation unit 201 assigns a total power of 50 W to the A port. After the second round of remaining power allocation, the additional power received by the A port is C₂: C₂=total allocated power of A port−P_{min_A}=50 W−30 W=20 W. The remaining power after the second round is P_{2_out}: P_{2_out}=P_{0_out}−C₁−C₂=40 W−10 W−20 W=10 W.

Since P_{2_out}>0, the third round of remaining power distribution continues. In the third round of distribution, the power allocation unit 201 assigns the smaller value between (P_{min_C1}+P_{2_out}) and the preset power of C1 port to the total power allocated to the C1 port. Since (P_{min_C1}+P_{2_out})=60 W and the preset power of C1 port is 70 W, the power allocation unit 201 allocates 60 W of total power to the C1 port. After the third round of remaining power distribution, the remaining power allocated to C1 is C₃=the total power allocated to the C1 port−P_{min_C1}=60 W−50 W=10 W. After the third round of distribution, the remaining power is P₃ out=P_{0_out}−C₁−C₂=0, and thus, the power distribution ends.

\textcircled{4} If only the W port, C1 port, and C2 port are connected to the receiving equipment, and assuming P_{max_out}=130 W, since (P_{min_W}+P_{min_C1}+P_{min_C2})<P_{max_out}<(the preset power of W port+the preset power of C1 port+the preset power of C2 port), the power allocation unit 201 first satisfies the minimum output power of W, C1, and C2, and then proceeds to allocate the remaining power according to the priority order. The initial remaining power is P_{0_out}=P_{max_out}−(P_{min_W}+P_{min_C1}+P_{min_C2})=10 W. The allocation rules are as follows:

In the first round of remaining power distribution, the power allocation unit 201 allocates the total power to the W port by selecting the smaller value between (P_{min_W}+remaining power P_{0_out}) and the preset power of W port. Since (P_{min_W}+remaining power P_{0_out})=30 W, and the preset power of W port is also 30 W, the power allocation unit 201 allocates 30 W of total power to the W port. After the first round of power distribution, the remaining power for the W port is C₁ which is calculated as: C₁=Total power allocated to W port−P_{min_W}=10 W. After the first round of remaining power distribution, the remaining power is: P_{1_out}=P_{0_out}−C₁=0 W. Since P_{1_out}=0, the power distribution ends. This means that the total power allocated to the W port is 30 W, and the total power allocated to the C1 and C2 ports is their minimum output power, which is 50 W.

Assuming P_{max_out}=140 W, since (P_{min_W}+P_{min_C1}+P_{min_C2})<P_{max_out}<(the preset power of the W port+the preset power of the C1 port+the preset power of the C2 port), the power allocation unit 201 first satisfies the minimum output power for the W, C1, and C2 ports, and then allocates the remaining power in sequence according to priority. The initial amount of remaining power, P_{0_out}, is calculated as: P_{0_out}=P_{max_out}−(P_{min_W}+P_{min_C1}+P_{min_C2})=20 W. The allocation rules are as follows:

During the first round of remaining power distribution, the power allocation unit 201 allocates the total power to the W port as the smaller value between (P_{min_W}+remaining power P_{0_out}) and the preset power of W port. Since (P_{min_W}+remaining power P_{0_out})=30 W and the preset power of W port is also 30 W, the power allocation unit 201 allocates a total of 30 W to the W port. After the first round of remaining power distribution, the remaining power for the W port is C₁, where C₁=the total power allocated to the W port−P_{min_W}=10 W. After the first round of remaining pow er distribution, the remaining power is P_{1_out}=P_{0_out}−C₁=10 W. Since P_{1_out}>0 and only the C1 and C2 charging output ports have not yet been allocated remaining power, the power allocation unit 201 evenly distributes the remaining power P_{1_out} between the second and third charging output ports (302,303), namely C1 port and C2 port. Both C1 port and C2 port receive 5 W. The power distribution is complete which means the total power allocated to the W port is 30 W, and the total power allocated to both C1 port and C2 port is 55 W each.

\textcircled{5} If the W port, A port, C1 port, and C2 port are all connected to receiving de vices:

Assume P_{max_out}=250 W. Since P_{max_out}>(the preset power of W port+the preset power of A port+the preset power of C1 port+the preset power of C2 port), the power allocation unit 201 allocates the preset power to the W port, A port, C1 port, and C2 port, respectively. That is, the power allocated to the W port is 30 W, the power allocated to the A port is 50 W, the power allocated to the C1 port is 70 W, and the power allocated to the C2 port is 70 W.

Assume P_{max_out}=150 W. Since P_{max_out}=(P_{min_W}+P_{min_A}+P_{min_C1}+P_{min_C2}), the power allocation unit 201 allocates the power to the W port, A port, C1 port, and C2 port according to their minimum output power. That is, the power allocated to the W port is 20 W, the power allocated to the A port is 30 W, the power allocated to the C1 port is 50 W, and the power allocated to the C2 port is 50 W.

Assume P_{max_out}=170 W. Since (P_{min_W}+P_{min_A}+P_{min_C1}+P_{min_C2})<P_{max_out}< (the preset power of W port+the preset power of A port+the preset power of C₁ port+the preset power of C2 port), the power allocation unit 201 first satisfies the minimum output power of the W port, A port, C1 port, and C2 port. At this point, the remaining power P_{0_out} is calculated as P_{max_out}−(P_{min_W}+P_{min_A}+P_{min_C1}+P_{min_C2})=170 W−150 W=20 W. The distribution rules for this remaining 20 W of power are as follows:

In the first round of remaining power distribution, the power allocation unit 201 allocates the total power to the W port by taking the smaller value of (P_{min_W}+remaining power P_{0_out}) and the preset power of W port. Since (P_{min_W}+remaining power P_{0_out})=40 W and the preset power of W port is 30 W, the power allocation unit 201 allocates a total power of 30 W to the W port. The remaining power C₁ for the W port is calculated as C₁=total power allocated to W port−P_{min_W}=30 W−20 W=1 OW. After the first round of power distribution, the remaining power P_{1_out}=P_{0_out}−C₁=20 W−10 W=10 W. Since P_{1_out}>0 and there are still 3 charging output ports that have not been allocated remaining power, with 2 charging output ports having the same lowest priority, the second round of remaining power distribution is performed.

In the second round of remaining power distribution, the power allocation unit 201 allocates the total power to the A port by taking the smaller value of (P_{min_A}+remaining power P_{1_out}) and the preset power of A port. Since (P_{min_A}+remaining power P_{1_out})=40 W and the preset power of A is 50 W, the power allocation unit 201 allo cates a total power of 40 W to the A port. After the second round of power distribution, the remaining power for the A port is calculated as C₂=total power allocated to A port−P_{min_A}=40 W−30 W=10 W. After the second round of power distribution, the remaining power P_{2_out}=P_{0_out}−C₁−C₂=20 W−10 W−10 W=0. Therefore, the remaining power P_{2_out}=0, which meets the termination condition, and the power distribution ends. This means that the total power allocated to the W port is 30 W, the total power allocated to the A port is 40 W, and the total power allocated to the C1 and C2 ports is their minimum output power, which is 50 W each.

Assuming P_{max_out}=200 W, since (P_{min_W}+P_{min_A}+P_{min_C1}+P_{min_C2})<P_{max_out}<(the preset power of W port+the preset power of A port+the preset power of C1 port+the preset power of C2 port), the power allocation unit 201 first satisfies the minimum output power for W, A, C1, and C2 ports. The remaining power at this point is P_{0_out}=P_{max_out}−(P_{min_W}+P_{min_A}+P_{min_C1}+P_{min_C2})=200 W−150 W=50 W. The distribution rule for this 50 W of remaining power is as follows:

In the first round of remaining power distribution, the power allocation unit 201 assigns the total power to the W port by taking the smaller value between (P_{min_W}+remaining power P_{0_out}) and the preset power of W port. Since (P_{min_W}+remaining power P_{0_out})=70 W, and the preset power of W port is 30 W, the power allocation unit 201 assigns 30 W as the total power for the W port. The remaining power C₁ for the W port is calculated as: C₁=the total power assigned to W port−P_{min_W}=30 W−20 W=10 W. After the first round of remaining power distribution, the remaining power P_{1_out}=P_{0_out}−C₁=50 W−10 W=40 W. Since P_{1_out}>0 and there are 3 charging output ports that have not yet received power, with 2 ports having the same lowest priority, the second round of remaining power distribution is initiated.

In the second round of remaining power distribution, the power allocation unit 201 assigns the total power to the A port by taking the smaller value between (P_{min_A}+remaining power P_{1_out}) and the preset power of A port. Since (P_{min_A}+remaining power P_{1_out})=70 W, and the preset power of A port is 50 W, the power allocation unit 201 assigns 50 W as the total power for the A port. After the second round of remaining power distribution, the remaining power C₂ for the A port is calculated as: C₂=the total power assigned to A port−P_{min_A}=50 W−30 W=20 W. After the second round of remaining power distribution, the remaining power P_{2_out}=P_{0_out}−C₁−C₂=50 W−10 W−20 W=20 W.

Since P_{2_out}>0 and only the C1 and C2 ports, which have the lowest priority, have not yet received the remaining power, the previous remaining power distribution rules are terminated. Instead, the remaining power P_{2_out} is evenly distributed between the C1 and C2 ports. Each port (C1 and C2) receives 10 W. Therefore, adding the minimum output power, the total power for C1 and C2 is 60 W each. At this point, the power configuration ends. The maximum output power of the portable energy storage device 200 W is distributed as follows: W port receives 30 W, A port receives 50 W, and both C1 and C2 ports receive 60 W each.

Specifically, among the W port, A port, C1 port, and C2 port, W and A ports can be unidirectional ports that only support discharge, while C1 and C2 ports can be bidirectional ports that support both charging and discharging. In this condition, the port able energy storage device provided by this embodiment can have 2 power input ports and 4 charging output ports, where the 2 power input ports are C1 and C2, and the charging output ports are W, A, C1, and C2.

The portable energy storage device provided by this embodiment ensures that when multiple charging output ports are connected to power-receiving devices and the total power demand of these devices exceeds the maximum power that the device can provide, all ports can operate according to the set minimum power. Furthermore, when multiple charging output ports are connected to power-receiving devices and the power is distributed according to the above rules, if during operation, a power-receiving dev ice is removed from one of the charging output ports, causing a change in the connected charging output ports, the power will be reallocated based on the number of currently connected power-receiving devices. This ensures that the power released from the port where the device was removed can be redistributed to the ports that still have connected devices, enabling the portable energy storage device to output its maximum available power and achieve dynamic adjustment.

Additionally, the portable energy storage device provided in this embodiment has charging output ports that are either all or partially prioritized, with these priorities being pre-set. As a result, users can decide the priority order of multiple power-receiving devices according to their actual needs when using the device.

### Embodiment 4

This embodiment provides a charging and discharging power distribution method for a portable energy storage device, which is applied to the portable energy storage devices capable of simultaneous multi-port charging and discharging as described in Embodiment 1 to Embodiment 3. The portable energy storage device includes a power allocation unit, at least two power input ports, and at least two charging output ports. The power allocation unit is used to configure power for the power input ports connect ed to the charging devices and the charging output ports connected to the power-receiving devices. The state where the power input port is connected to a charging device and the charging output port is connected to a power-receiving device is defined as the charging and discharging (bi-directional) state.

The charging and discharging power distribution method includes:

The method defines the maximum allowable operating power of the portable energy storage device in the charging and discharging state as Pₘₐₓ. The power allocation unit allocates half of Pₘₐₓ (Pₘₐₓ/2) as the maximum allowable input power for the power input ports and ensures that the actual total charging power of the power input ports equals the maximum total output power of the charging output ports. The maximum allowable input power for the power input ports is defined as P_{max_in}, and the maximum total output power of the charging output ports is defined as P_{max_out}. Therefore, P_{max_in}=Pₘₐₓ/2, and P_{max_out} equals the actual total charging power of the power input ports, with the condition P_{max_out}=P_{max_in}.

When the sum of the maximum allowable charging power of the power input ports connected to charging devices is less than or equal to P_{max_in}, the power allocation unit configures these power input ports to operate at their maximum allowable charging power. The maximum allowable charging power is the smaller value of the preset maximum charging power of the power input ports and the charging power that the charging device can provide when inserted into the port. When the sum of the maximum allowable charging power of the power input ports connected to charging devices exceeds P_{max_in}, the power allocation unit configures these power input ports to operate with a total charging power of P_{max_in}.

When the sum of the preset power of the charging output ports connected to the load devices is less than or equal to P_{max_out}, the power allocation unit assigns each charging output port connected to a load device its corresponding preset power. The preset power is the smaller value of the maximum output power of the charging output port and the load request power. When the sum of the preset power of the charging output ports connected to the load devices exceeds P_{max_out}, the power allocation unit assigns the total power of these charging output ports to be P_{max_out}.

It should be noted that in this invention, the power assigned to a certain power input port refers to its operating power. For example, when it is stated that a certain power input port operates at 50 W, it means that the power allocation unit assigns 50 W to that power input port. The total power assigned to a certain charging output port is usually the operating power of that port, but there are two special cases:
1. After the remaining power is evenly distributed to the lowest-priority charging output ports, if the total power assigned to a port is (remaining power+minimum out put power) is greater than or equal to the preset power of the port, the port will ultimately operate at the preset power.
2. If the total power assigned to a port is equal to the minimum output power of that port, and if the minimum output power is greater than the load request power, the port will ultimately operate at the load request power.

The specific embodiments of the present invention have been described above. From the above description, it is clear that those skilled in the art can make various changes and modifications without departing from the scope of the technical idea of the present invention.

1. A portable energy storage device capable of simultaneous multi-port charging and discharging, wherein:
the device comprises a power allocation unit, at least two power input ports, and at least two charging output ports; The power allocation unit is configured to distribute power to the power input ports connected to charging devices and the charging output ports connected to powered devices; The state in which the power input ports are connected to charging devices while the charging output ports are simultaneously connected to powered devices is defined as the simultaneous charging and discharging state;
define the maximum allowable operating power of the portable energy storage device under the state of charging and discharging as Pₘₐₓ, the power allocation unit configures ½ of Pₘₐₓ as the maximum allowable input power of the power input port, and configures the sum of actual charging power of the power input port to be the maximum total output power of the charging output port; define the maximum allowable input power of the power input port to be P_{max_in} and the maximum total output power of the charging output port to be P_{max_out}; then P_{max_in}=Pₘₐₓ/2, P_{max_out} is the sum of the actual charging power of the power input port and P_{max_out}≤P_{max_in};
when the sum of the maximum allowable charging power of the power input ports connected to charging devices is less than or equal to P_{max_in}, the power allocation unit configures each power input port to operate at its respective maximum allowable charging power; the maximum allowable charging power is defined as the smaller value between the preset maximum charging power of the power input port and the charging power that the charging device can provide upon connection; when the sum of the maximum allowable charging power of the power input ports connected to charging devices exceeds P_{max_in}, the power allocation unit sets the total operating power of these power input ports to P_{max_in};
when the sum of the preset power of the charging output ports connected to powered devices is less than or equal to P_{max_out}, the power allocation unit assigns each charging output port its corresponding preset power; the preset power is defined as the smaller value between the maximum output power of the charging output port and the power requested by the connected load; when the sum of the preset power of the charging output ports connected to powered devices exceeds P_{max_out}, the power allocation unit ensures that the total power distributed to these charging output ports equals P_{max_out}.

2. The portable energy storage device capable of simultaneous multi-port charging and discharging according to claim 1, wherein:
when the sum of the maximum allowable charging power of the power input ports connected to charging devices exceeds P_{max_in}, the power allocation unit sets the total operating power of these power input ports to P_{max_in} and allocates power according to the following rules:
if the number of power input ports connected to charging devices is one, the power allocation unit configures the power input port to operate at P_{max_in};
if the number of power input ports connected to charging devices is N, where N is a positive integer and N≥2, then:
if the maximum allowable charging power of each power input port is greater than P_{max_in}/N, the power allocation unit configures all these power input ports to operate at P_{max_in}/N;
if some power input ports have a maximum allowable charging power which is less than or equal to P_{max_in}/N, the power allocation unit performs a first power allocation, configuring these power input ports to operate at their maximum allowable charging power; Assuming the total power consumed by these power input ports is B₁, the remaining power available for allocation is P₁=P_{max_in}−B₁; The number of power input ports that have not yet been allocated power is M₁ which equals to N−(the number of power input ports configured to operate at their maximum allowable charging power in the first allocation); For the remaining M₁ power input ports:
if the maximum allowable charging power of each remaining power input port is greater than P₁/M₁, the power allocation unit configures all M₁ remaining power input ports to operate at P₁/M₁;
if the maximum allowable charging power of some power input ports is less than or equal to P₁/M₁, then the power allocation unit allocates power in accordance with the following rule: after the k-th power allocation, the total power consumed by the power input ports configured to operate at their maximum allowable charging power is defined as Bₖ; the remaining power available for allocation is defined as Pₖ, and the number of power input ports that have not yet been allocated power is defined as Mₖ, where k is a positive integer and k≥1;
among the remaining Mₖ ports, for the power input ports with a maximum allowable charging power which is less than or equal to Pₖ/Mₖ, the power allocation unit performs the (k+1)-th power allocation, configuring these power input ports to operate at their maximum allowable charging power; assuming the total power consumed by these power input ports is Bₖ₊₁, the remaining power available for allocation is Pₖ₊₁=P_{max_in}−B₁ . . . Bₖ₊₁, and the number of power input ports that have not yet been allocated power is Mₖ₊₁=Mₖ−(the number of power input ports configured to operate at their maximum allowable charging power in the (k+1)-th allocation; in this rule, after the (k+1)-th power allocation, if the maximum allowable charging power of all the remaining Mₖ₊₁ power input ports is greater than Pₖ₊₁/Mₖ₊₁, the rule terminates and the power allocation unit configures the remaining Mₖ₊₁ power input ports to operate at Pₖ₊₁/Mₖ₊₁.

3. The portable energy storage device capable of simultaneous multi-port charging and discharging according to claim 1, wherein:
when the sum of the preset power of the charging output ports connected to powered devices exceeds P_{max_out}, the power allocation unit distributes a total power of P_{max_out} among these charging output ports and allocates power according to the following rules:
the charging output ports are preconfigured with a priority order for power allocation, and each charging output port is preassigned a minimum output power and a maximum output power; the sum of the minimum output power of each charging output port is less than or equal to P_{max_out}, and the minimum output power of each charging output port is less than or equal to its maximum output power; additionally, the maximum output power of each charging output port is less than or equal to P_{max_out};
if the sum of the minimum output power of the charging output ports connected to powered devices is equal to P_{max_out}, the power allocation unit assigns each charging output port its corresponding minimum output power;
if the sum of the minimum output power of the charging output ports connected to powered devices is less than P_{max_out}, and P_{max_out} is less than the sum of the preset power of these charging output ports, the power allocation unit first satisfies the minimum output power requirements of these charging output ports; then, it distributes the remaining power according to the priority order of the charging output ports, where the remaining power is given by: remaining power=P_{max_out}−Sum of Minimum Output Power of Charging Output Ports.

4. The portable energy storage device capable of simultaneous multi-port charging and discharging according to claim 3, wherein:
when the sum of the minimum output power of the charging output ports connected to powered devices is less than P_{max_out}, and P_{max_out} is less than the sum of the preset power of these charging output ports, the power allocation unit, after satisfying the minimum output power requirements of these charging output ports, distributes the remaining power according to the priority order of the charging output ports based on the following rules:
define the number of charging output ports connected to powered devices as Y; when Y≥2 and these Y charging output ports have different priority levels, they are sorted in descending order of priority and sequentially designated as the first charging output port through the Y-th charging output port; their respective minimum output power values are sequentially defined as P_{min_c1} to P_{min_cY}, and the smaller value between their maximum output power and load request power is sequentially defined as the first preset power through the Y-th preset power;
define the initial amount of remaining power as P_{0_out}, where: P_{0_out}=P_{max_out} (P_{min_c1}+ . . . +P_{min_cY}); during the first round of remaining power allocation, the power allocation unit assigns the first charging output port a total power equal to the smaller value between (P_{min_c1}+P_{0_out}) and the first preset power; Define the remaining power obtained by the first charging output port after the first round of allocation as C₁, where: C₁=total power allocated to the first charging output port−P_{min_c1}; define the remaining power after the first round of allocation as P_{1_out}, where: P_{1_out}=P_{0_out}−C₁; if P_{1_out}=0, the power allocation process ends; if P_{1_out}>0, the remaining power allocation continues according to the following rule until the remaining power P_{k_out}=0, thereby completing the power allocation process: in the k-th round of remaining power allocation, the power allocation unit assigns the k-th charging output port a total power equal to the smaller value between (P_{min_ck}+P₍ₖ₋₁₎ₒᵤₜ) and the k-th preset power; define the remaining power obtained by the k-th charging output port after the k-th round of allocation as Cₖ, where: Cₖ=Total power allocated to the k-th charging output port-P_{min_ck}; define the remaining power after the k-th round of allocation as P_{k_out}, where: P_{k_out}=P_{0_out}−C₁− . . . −Cₖ, where k is a positive integer and k≥2.

5. The portable energy storage device capable of simultaneous multi-port charging and discharging according to claim 3, wherein:
when the sum of the minimum output power of the connected charging output ports is less than P_{max_out}, and P_{max_out} is less than the sum of the preset power of these charging output ports, the power allocation unit, after ensuring that each charging output port receives its minimum output power, distributes the remaining power according to the priority order of the charging output ports based on the following rules:
define the number of charging output ports connected to the powered devices as Y; Among these Y charging output ports, the number of charging output ports with the same lowest priority is x, while the remaining Y−x charging output ports have different priority levels; Then:
when Y≥2 and Y=x, meaning that all Y charging output ports share the same lowest priority, the power allocation unit first ensures that these charging output ports receive their respective minimum output power and then evenly distributes the remaining power among them;
when Y≥3 and 2≤x<Y, the charging output ports are sorted in order of priority from high to low; these ports are sequentially defined from the first charging output port to the Y-th charging output port, where the priority of charging output ports from the (Y−x+1)-th to the Y-th is the same; the minimum output power of these charging output ports is sequentially defined as P_{min_c1} to P_{min_cY}, and the smaller value between their maximum output power and load request power is sequentially defined as the first preset power through the Y-th preset power; define the initial amount of remaining power as P_{0_out}, where: P_{0_out}=P_{max_out}−(P_{min_c1}+ . . . +P_{min_cY}); The remaining power distribution rule is as follows:
in the first round of remaining power distribution, the power allocation unit assigns the total power to the first charging output port, which is the smaller value between (P_{min_c1}+remaining_power P_{0_out}) and the first preset power; define the remaining power obtained by the first charging output port after the first round of remaining power distribution as C₁, where: C₁=Total power allocated to the first charging output port−P_{min_c1}; define the remaining power after the first round of distribution as P_{1_out}, where: P_{1_out}=P_{0_out}−C₁; if P_{1_out}=0, the power allocation ends; if P_{1_out}>0 and only x charging output ports have not been allocated remaining power, the power allocation unit will evenly distribute the remaining power P_{1_out} among these x charging output ports, and the power allocation ends; if P_{1_out}>0 and more than x charging output ports still require power allocation, the power allocation unit continues the remaining power distribution according to the following rules until one of the following conditions is met:
the remaining power distribution rule is as follows: in the k-th round of remaining power distribution, the power allocation unit allocates the total power to the k-th charging output port, which is the smaller value between (P_{min_ck}+remaining_powerP_{k-1_out}) and the k-th pre set power; define the remaining power obtained by the k-th charging output port after the k-th round of remaining power distribution as Cₖ, where: Cₖ=Total power allocated to the k-th charging output port−P_{min_ck}; define the remaining power after the k-th round of distribution as P_{k_out}, where: P_{k_out}=P_{0_out}−C₁− . . . −Cₖ;
the first condition is: the remaining power P_{k_out} equals 0; the second condition is: The remaining power P_{k_out} is greater than 0, and only x charging output ports have not yet been allocated the remaining power; if the first condition is met first, the power distribution ends; if the second condition is met first, the remaining power P_{k_out} will be evenly distributed among the remaining x charging output ports, and then the power distribution ends, where k is a positive integer and k≥2.

6. The portable energy storage device capable of simultaneous multi-port charging and discharging according to claim 1, wherein:
the number of power input ports is two, and the number of charging output ports is four; the two power input ports are bidirectional ports capable of both charging and discharging, and two of the charging output ports are the said bidirectional ports.

7. The portable energy storage device capable of simultaneous multi-port charging and discharging according to claim 1, wherein:
the device is internally equipped with a main control board and one or more independent circuit boards connected to the main control board; the power input ports and charging output ports are arranged on the circuit boards, while the power allocation unit is configured on the main control board.

8. The portable energy storage device capable of simultaneous multi-port charging and discharging according to claim 7, wherein:
the power allocation unit configures the charging and discharging power of each power input port and charging output port by reading the preset parameters of the power input ports and charging output ports, calculating their real-time power demands accordingly; the preset parameters include current and voltage.

9. The portable energy storage device capable of simultaneous multi-port charging and discharging according to claim 7, wherein:
both the charging/discharging interface circuit board and the main control board are equipped with protection circuits; the protection circuits include one or more of an overcurrent protection circuit, an overvoltage protection circuit, an overtemperature protection circuit, and a short-circuit protection circuit; when an abnormal condition is detected, the protection circuit responds and cuts off the power supply to the relevant circuit.

10. A method for allocating charging and discharging power in a portable energy storage device, applied to a portable energy storage device capable of simultaneous multi-port charging and discharging, wherein:
the portable energy storage device comprises a power allocation unit, at least two power input ports, and at least two charging output ports; the power allocation unit is configured to allocate power to the power input ports connected to charging devices and the charging output ports connected to receiving devices; the state in which the power input ports are connected to charging devices while the charging output ports are also connected to receiving devices is defined as the charge-discharge simultaneous operation state;
the power allocation method for charging and discharging includes:
defining the maximum allowable operating power of the portable energy storage device in the charge-discharge simultaneous operation state as Pₘₐₓ; the power allocation unit configures ½ of Pₘₐₓ as the maximum allowable input power for the power input ports and ensures that the total actual charging power of the power input ports equals the maximum total output power of the charging output ports; defining the maximum allowable input power of the power input ports as P_{max_in} and the maximum total output power of the charging output ports as P_{max_out}, the relationships are: P_{max_in}=Pₘₐₓ/2, P_{max_out}=total actual charging power of the power input ports, with the condition P_{max_out}≤P_{max_in};
when the sum of the maximum allowable charging power of the connected power input ports
is less than or equal to P_{max_in}, the power allocation unit configures these power input ports to operate at their respective maximum allowable charging power; the maximum allowable charging power is the smaller value between the preconfigured maximum charging power of the power input port and the charging power that the connected charging device can provide when plugged into that port; when the sum of the maximum allowable charging power of the connected power input ports>P_{max_in}, the power allocation unit configures these power input ports to operate with a total power equal to P_{max_in};
when the sum of the preset power of the connected charging output ports is less than or equal to P_{max_out}, the power allocation unit assigns each connected charging output port its corresponding preset power; the preset power is the smaller value between the maximum output power of the charging output port and the power requested by the load connected to that port; when the sum of the preset power of the connected charging output ports exceeds P_{max_out}, the power allocation unit ensures that the total power allocated to these charging output ports is P_{max_out}.
